(19) United States
(12) Patent Application Publication
(10) Pub. No.: US 2025/0061025 A1
(43) Pub. Date: Feb. 20, 2025

(54) STORAGE SERVER STARTUP DETECTION METHOD, SYSTEM AND APPARATUS, DEVICE, AND STORAGE MEDIUM

(71) Applicant: SUZHOU METABRAIN INTELLIGENT TECHNOLOGY CO., LTD., Suzhou, Jiangsu (CN)

(72) Inventor: Jiayang ZHOU, Suzhou, Jiangsu (CN)

(21) Appl. No.: 18/725,092

(22) PCT Filed: Jan. 16, 2023
(86) PCT No.: PCT/CN2023/072366

§ 371 Date: Jun. 27, 2024

(30) Foreign Application Priority Data
Aug. 9, 2022 (CN) 202210947638.0

(51) Int. Cl. G06F 11/14; G06F 11/07

(52) U.S. Cl. CPC G06F 11/1417; G06F 11/0772; G06F 11/1438

(57) ABSTRACT

The present application relates to the technical field of computers, and discloses a storage server startup detection method, system and apparatus, a device, and a storage medium. The method comprises: when starting a target storage server, receiving a real-time digital signal sent by an operating system of the target storage server, wherein the real-time digital signal comprises a pulse flag bit representing a startup state of the target storage server; detecting the real-time digital signal according to a preset detection period to obtain a detection result; and sending the detection result to a single-chip microcomputer provided in the target storage server, such that the single-chip microcomputer determines, according to the detection result, whether the target storage server is successfully started.

### CROSS REFERENCE TO RELATED APPLICATION

The present application claims the priority of the Chinese patent application 202210947638.0, titled “STORAGE SERVER STARTUP DETECTION METHOD, SYSTEM AND APPARATUS, DEVICE, AND STORAGE MEDIUM” and filed with China National Intellectual Property Administration on Aug. 9, 2022, which is incorporated herein by reference in their entirety.

### TECHNICAL FIELD

The present application relates to the field of computer technology, and in particular to a storage server startup detection method, system, apparatus, device and storage medium.

### BACKGROUND

Storage server is also a storage server product, and its massive storage space and powerful performance experience are generally applicable to various fields such as the Internet, large data centers, communications, finance, etc. During power-on and startup, due to power supply problems, firmware problems, hardware device problems, etc., the storage product May fail to start up normally and enter the system. This will lead to the failure of the storage server product startup, reduce the user experience, and even lead to business paralysis. In the conventional technology, whether the storage server is started successfully is generally judged manually, and if the startup fails, it is handled manually. Although the problem may be solved to a certain extent, it treats the symptoms rather than the root cause, and because the failure is not easy to reproduce, the probability of misjudgment due to manual judgment is also common.

### SUMMARY

In view of this, an objective of the present application is to provide a storage server startup detection method, system, apparatus, device, and storage medium. The target storage server detects a startup result of the target storage server based on data interaction between an operating system, an underlying control chip and a microcontroller, so as to solve the problem of a startup failure of the target storage server. The specific solution is as follows.

The present application provides a storage server startup detection method applied to an underlying control chip provided in the target storage server, including:

receiving a real-time digital signal sent by an operating system of the target storage server during startup of the target storage server, wherein the real-time digital signal comprises a pulse flag bit representing a startup state of the target storage server;

detecting the real-time digital signal based on a predetermined detection period to obtain a detection result; and

sending the detection result to a microcontroller provided in the target storage server, so that the microcontroller determines whether the target storage server is started successfully based on the detection result.

In some embodiments of the present application, before the receiving the real-time digital signal sent by the operating system of the target storage server, the method further includes:

sending, by the operating system of the target storage server, the real-time digital signal to the underlying control chip provided in the target storage server through an input/output interface of a processor provided in the target storage server.

In some embodiments of the present application, the detecting the real-time digital signal based on the predetermined detection period to obtain the detection result includes:

detecting the pulse flag bit in the real-time digital signal based on the predetermined detection period, and generating a first detection result representing that high and low pulses satisfying the predetermined change condition are not detected when high and low pulses satisfying the predetermined change condition are detected to be not present in the pulse flag bit.

In some embodiments of the present application, the storage server startup detection method further includes:

determining that the high and low pulses satisfying the predetermined change condition are not present in the pulse flag bit when high and low pulses with a predetermined change period are detected to be not present in the pulse flag bit in the real-time digital signal within a predetermined time.

In some embodiments of the present application, the sending the detection result to the microcontroller provided in the target storage server, so that the microcontroller determines whether the target storage server is started successfully based on the detection result, includes:

sending the first detection result to the microcontroller provided in the target storage server, so that the microcontroller determines that the target storage server fails to start based on the first detection result.

In some embodiments of the present application, the sending the first detection result to the microcontroller provided in the target storage server includes:

sending, by a field programmable gate array, the first detection result to the target storage server through a serial peripheral interface when the underlying control chip provided in the target storage server is the field programmable gate array

In some embodiments of the present application, the detecting the real-time digital signal according to the predetermined detection period to obtain the detection result, includes:

setting the value of the predetermined detection period to a value not lower than the detection frequency threshold according to detection requirements; and

detecting the real-time digital signal in real time according to the set value of the predetermined detection period to obtain the detection result.

In some embodiments of the present application, the setting the value of the predetermined detection period to the value not lower than the detection frequency threshold according to detection requirements comprises:

setting the value of the predetermined detection period to 50 Mhz according to high-frequency detection requirements, so that the underlying control chip detects the real-time digital signal in real time at a rate of 50 Mhz.

In some embodiments of the present application, wherein after the sending the detection result to the microcontroller provided in the target storage server, so that the microcontroller determines whether the target storage server starts successfully, the method further includes:

controlling the target storage server to restart when the microcontroller determines that the target storage server fails to start based on the detection result.

In some embodiments of the present application, after the controlling, by the microcontroller, the enable switch on the motherboard of the target storage server to enter the off state by sending the non-enable signal, the method further includes:

performing, by the target storage server, a power-off refresh operation to restart the operating system of the target storage server.

In some embodiments of the present application, after the controlling, by the microcontroller, the enable switch on the motherboard of the target storage server to enter the off state by sending a non-enable signal, the method further includes:

triggering, by a timer provided in the target storage server, the microcontroller to control the enable switch on the motherboard of the target storage server to switch to an on state by sending an enable signal.

The present application provides a server startup detection system, including an underlying control chip provided in a target storage server, an operating system of the target storage server, and a single-chip microcontroller provided in the target storage server, wherein:

the underlying control chip provided in the target storage server is configured for receiving a real-time digital signal sent by the operating system of the target storage server during startup of the target storage server, wherein the real-time digital signal contains a pulse flag bit representing a startup state of the target storage server; and detecting the real-time digital signal according to the predetermined detection period to obtain a detection result; and sending the detection result to the microcontroller provided in the target storage server; and

the microcontroller provided in the target storage server is configured for determining whether the target storage server starts successfully based on the detection result.

The present application provides a server startup detection device applied to an underlying control chip provided in the target storage server, including:

a signal receiving module configured for receiving a real-time digital signal sent by the operating system of the target storage server during startup of the target storage server, wherein the real-time digital signal includes a pulse flag bit representing a startup status of the target storage server;

a signal detection module configured for detecting the real-time digital signal according to a predetermined detection period to obtain a detection result;

a startup determination module configured for sending the detection result to the microcontroller provided in the target storage server, so that the microcontroller determines whether the target storage server is started successfully based on the detection result.

The present application provides an electronic device, wherein the electronic device comprises a processor and a memory for storing a computer program, and the computer program is loaded and executed by the processor to implement the above server startup detection method.

The present application provides a non-transitory computer-readable storage medium, wherein the non-transitory computer-readable storage medium stores a computer-executable instruction which, when loaded and executed by a processor, implements the above server startup detection method.

In the present application, the real-time digital signal sent by the operating system of the target storage server is firstly received during the startup of the target storage server, and the real-time digital signal contains a pulse flag bit representing the startup status of the target storage server. Then, the real-time digital signal is detected based on the predetermined detection period to obtain the detection result. Finally, the detection result is sent to the microcontroller provided in the target storage server, so that the microcontroller may determine whether the target storage server is started successfully based on the detection result. It may be seen that the executive object is the underlying control chip. The operating system is configured to send the real-time digital signal to the underlying control chip. The underlying control chip receives the real-time digital signal and continuously detects it and sends the detection result to the microcontroller. The microcontroller determines the startup result of the target storage server based on this. The target storage server detects the startup result of the target storage server based on data interaction between the operating system, the underlying control chip and the microcontroller, thereby solving the problem of startup failure of the target storage server.

### BRIEF DESCRIPTION OF THE DRAWINGS

In order to more clearly illustrate technical solutions in the embodiments of the present application or in the conventional technology, the figures that are required to describe the embodiments or the conventional technology are briefly introduced below. Apparently, the figures described below are embodiments of the present application, and a person skilled in the art may obtain other figures according to these figures without paying creative efforts.

FIG. 1 is a flowchart of a storage server startup detection method provided in the present application;

FIG. 2 is a flowchart of a specific storage server startup detection method provided in the present application;

FIG. 3 is a flowchart of a specific storage server startup detection method provided in the present application;

FIG. 4 is a structure diagram of a target storage server startup detection system provided by the present application;

FIG. 5 is a schematic structure diagram of a storage server startup detection apparatus provided in the present application; and

FIG. 6 is a structure diagram of a storage server startup detection electronic device provided in the present application.

### DEEMPENNAGEED DESCRIPTION OF THE EMBODIMENTS

The technical solutions in the embodiments of the present application will be clearly and completely described below with reference to the accompanying drawings in the embodiments of the present application. Apparently, the described embodiments are only some of the embodiments of the present application, rather than all of the embodiments. Based on the embodiments in the present application, all other embodiments obtained by those of ordinary skill in the art without creative efforts fall within the protection scope of the present application.

At present, during power-on startup, due to power supply problems, firmware problems, hardware device problems, etc., the storage product may not be normally started and enter the system, resulting in the storage server product startup failure, reducing the user experience, and even leading to business paralysis. In the conventional technology, whether the storage server is started successfully is generally judged manually, and if the startup fails, it is handled manually. Although the problem may be solved to a certain extent, it treats the symptoms rather than the root cause, and because the failure is not easy to be reproduced, the probability of misjudgment due to manual judgment is also common. In view of the above technical defects, the present application provides a storage server startup detection solution. The execution object is the underlying control chip. The operating system is used to send a real-time digital signal to the underlying control chip. The underlying control chip receives the real-time digital signal and continuously detects the real-time digital signal, and sends the detection result to the microcontroller. The microcontroller determines the startup result of the target storage server based on this. The target storage server detects the startup result of the target storage server based on data interaction between the operating system, the underlying control chip and the microcontroller, thereby solving the problem of startup failure of the target storage server.

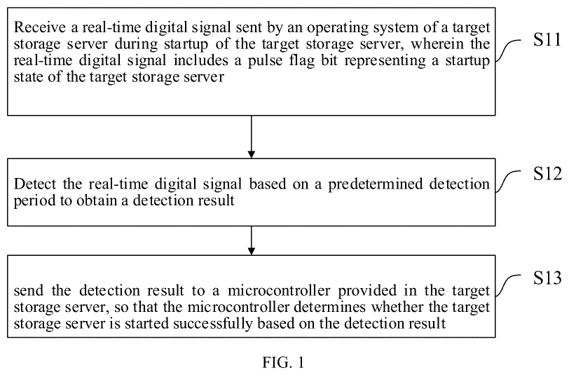

FIG. 1 is a flowchart of a storage server startup detection method provided in the present application. As shown in FIG. 1, the storage server startup detection method is applied to the underlying control chip provided in the target storage server, which includes S11-S13.

In S11, a real-time digital signal sent by an operating system of the target storage server is received during startup of the target storage server, where the real-time digital signal contains a pulse flag bit that represents a startup state of the target storage server.

In some embodiments of the present application, an underlying control chip and a microcontroller are deployed in the target storage server, and the operating system of the target storage server mainly interacts with the underlying control chip for data. The underlying control chip and the microcontroller are original components in the target storage server. In addition to performing their own inherent tasks, they also compatibly perform startup detection tasks for the target storage server.

In some embodiments of the present application, the operating system of the target storage server sends the real-time digital signal to the underlying control chip provided in the target storage server during the startup of the target storage server. The underlying control chip receives the real-time digital signal sent by the operating system of the target storage server. Further, the operating system of the target storage server sends the real-time digital signal to the underlying control chip provided in the target storage server through an input/output interface of a processor provided in the target storage server. The input/output interface is also an I/O interface.

It should be noted that the real-time digital signal contains a pulse flag bit that represents the startup state of the target storage server. In subsequent detection, the underlying control chip mainly detects the pulse flag bit in the real-time digital signal. The pulse flag bit may be a high or low level flag, such as “0” or “1”. The change of the pulse flag bit may be used to reflect whether the target storage server is started successfully or enters the operating system successfully. Therefore, the real-time digital signal is essentially a signal representing that the operating system has been started. The operating system transmits the signal representing that the operating system has been started to the underlying control unit. i.e., the underlying control chip provided in the target storage server, through the I/O interface of the processor CPU.

In S12, the real-time digital signal is detected based on the predetermined detection period to obtain a detection result.

In some embodiments of the present application, after the underlying control chip receives the real-time digital signal sent by the operating system, the underlying control chip detects the real-time digital signal based on the predetermined detection period, and finally obtains the corresponding detection result. It may be understood that the detection process of the underlying control chip may be considered as passive detection or active detection. The passive detection is due to a fact that the underlying control chip needs to detect the real-time digital signal after receiving it, and the active detection is due to a fact that the underlying control chip actively detects the real-time digital signal after receiving it.

In S13, the detection result is sent to the microcontroller provided in the target storage server, so that the microcontroller determines whether the target storage server is started successfully based on the detection result.

In some embodiments of the present application, after the underlying control chip detects the real-time digital signal, the detection result is sent to the microcontroller provided in the target storage server, and the microcontroller determines whether the target storage server is started successfully based on the detection result. The microcontroller is located on the motherboard. After receiving the detection result, the microcontroller performs determination processing. It has its own determination logic. By executing the determination logic, it may determine whether the target storage server is started successfully based on the detection result.

It may be seen that, in some embodiments of the present application, the real-time digital signal sent by the operating system of the target storage server is firstly received during the startup of the target storage server, and the real-time digital signal contains a pulse flag bit representing the startup state of the target storage server. Then, the real-time digital signal is detected based on the predetermined detection period to obtain the detection result. Finally, the detection result is sent to the microcontroller provided in the target storage server, so that the microcontroller may determine whether the target storage server is started successfully based on the detection result. In some embodiments of the present application, the executive object is the underlying control chip. The operating system is configured to send the real-time digital signal to the underlying control chip. After receiving the real-time digital signal, the underlying control chip continuously detects it and sends the detection result to the microcontroller. The microcontroller determines the startup result of the target storage server based on this. The target storage server detects the startup result of the target storage server based on data interaction between the operating system, the underlying control chip and the microcontroller, thereby solving the problem of startup failure of the target storage server.

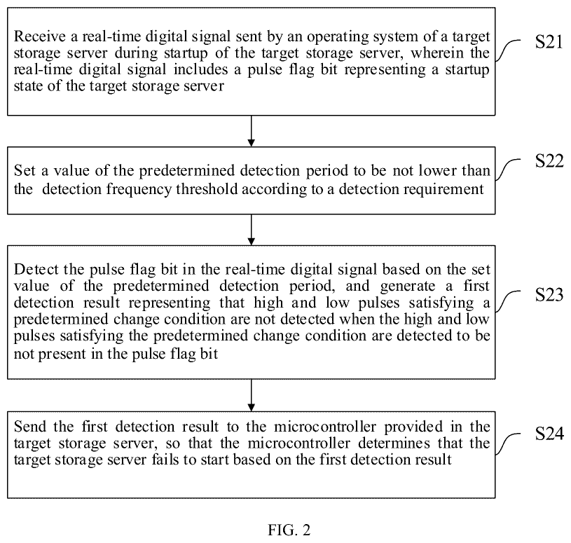

FIG. 2 is a flowchart of a specific storage server startup detection method provided in the present application. As shown in FIG. 2, the storage server startup detection method is applied to the underlying control chip provided in the target storage server, including S21-S24.

In S21, a real-time digital signal sent by an operating system of the target storage server is received during startup of the target storage server, where the real-time digital signal contains a pulse flag bit that represents a startup state of the target storage server.

In some embodiments of the present application, for the specific process of the above step S21, reference may be made to the corresponding content disclosed in the above embodiment, which will not be repeated here.

In S22, a value of the predetermined detection period is set to be not lower than a detection frequency threshold according to a detection requirement.

In some embodiments of the present application, for the real-time digital signal, the higher the detection rate of the underlying control chip, the higher the detection accuracy. Generally, high-frequency detection is required. Therefore, before the detection is performed, the value of the predetermined detection period may be set to a value not lower than the detection frequency threshold according to the detection requirements. For example, the value of the predetermined detection period may be set to 50 Mhz according to high-frequency detection requirements, so that the underlying control chip detects the real-time digital signal in real time at a rate of 50 Mhz. That is, the rate may be set to 50 Mhz. In this embodiment, the detection frequency threshold is not limited and may be set according to business requirements. When the detection accuracy is required to be high, the predetermined detection period may be set higher, that is, the detection frequency is higher.

In S23, a pulse flag bit in a real-time digital signal is detected according to the set value of the predetermined detection period. When high and low pulses satisfying a predetermined change condition are detected to be not present in the pulse flag bit, a first detection result representing that the high and low pulses satisfying the predetermined change condition are not detected is generated.

In some embodiments of the present application, the underlying control chip detects the pulse flag bit in the real-time digital signal according to the set value of the predetermined detection period. For example, after the underlying control chip sets the predetermined detection period, it detects the real-time digital signal at a rate of 50 Mhz. When the underlying control chip detects that high and low pulses satisfying the predetermined change condition are not present in the pulse flag bit, a first detection result representing that high and low pulses satisfying the predetermined change condition are not detected is generated. Specifically, if high and low pulses satisfying a predetermined change condition are detected to be not present in the pulse flag bit of the real-time digital signal within a predetermined time, the high and low pulses satisfying the predetermined change condition are not present in the pulse flag bit. That is, the predetermined change condition may be that high and low pulses with high and low changes of the operating system cannot be detected within a specified time.

It may be understood that if the target storage system is started normally and enters the operating system, the operating system sends high and low pulses with a 2-second change to the underlying control chip in the form of a signal through the I/O interface. When the underlying control chip detects the real-time digital signal in real time at a rate of 50 Mhz, it cannot detect the high and low pulses with the 2-second change. The underlying control chip generates the first detection result representing that the high and low pulses satisfying the predetermined change condition are not detected.

In S24, the first detection result is sent to the microcontroller provided in the target storage server, so that the microcontroller determines that the target storage server fails to start based on the first detection result.

In some embodiments of the present application, the underlying control chip sends the first detection result to the microcontroller provided in the target storage server, so that the microcontroller determines that the target storage server fails to start based on the first detection result. Since the first detection result represents that high and low pulses with high and low changes are not detected, and its essence represents that the target storage server fails to start and enter the operating system. Therefore, the microcontroller determines the first detection result through its own determination logic and then determines that the target storage server fails to start.

It may be seen that, in some embodiments of the present application, the underlying control chip sets the value of the predetermined detection period to be not lower than the detection frequency threshold according to a detection requirement. After receiving the real-time digital signal sent by the operating system, it further detects the pulse flag bit in the real-time digital signal based on the set value of the predetermined detection period. When high and low pulses satisfying the predetermined change condition are detected to be not present in the pulse flag bit, a first detection result representing the high and low pulses satisfying the predetermined change condition are not detected is generated. Finally, the microcontroller determines that the target storage server fails to start based on the first detection result. In some embodiments of the present application, the detection frequency is set, and the change of the inherent digital signal during server startup is used as a basis for determining whether the startup is successful, thereby improving detection flexibility and accuracy.

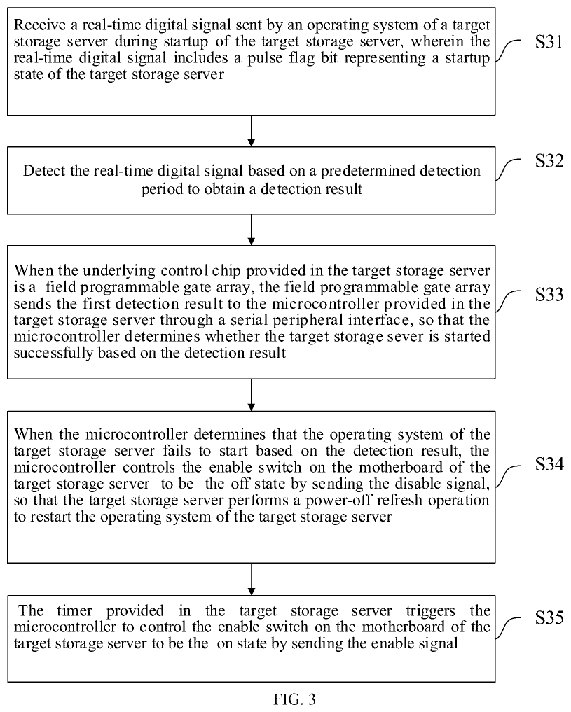

FIG. 3 is a flowchart of a specific storage server startup detection method provided in the present application. As shown in FIG. 3, the storage server startup detection method is applied to the underlying control chip provided in the target storage server, including S31-S34.

In S31, a real-time digital signal sent by an operating system of the target storage server is received during startup of the target storage server, where the real-time digital signal contains a pulse flag bit that represents a startup state of the target storage server.

In some embodiments of the present application, for the specific process of the above step S31, reference may be made to the corresponding content disclosed in the above embodiment, which will not be repeated here.

In S32, the real-time digital signal is detected based on the predetermined detection period to obtain a detection result.

In S33, when the underlying control chip provided in the target storage server is a FPGA, the FPGA sends the detection result to the microcontroller provided in the target storage server through the serial peripheral interface, so that the microcontroller determines whether the target storage server is started successfully based on the detection result.

In some embodiments of the present application, the underlying control chip is limited to a field programmable gate array. The field programmable gate array is a FPGA. The FPGA has high sampling real-time performance and sampling rate. Specifically, when the underlying control chip provided in the target storage server is a FPGA, the FPGA mainly sends the detection result to the microcontroller provided in the target storage server through the serial peripheral interface, so that the microcontroller determines whether the target storage server is started successfully based on the detection result. The serial peripheral interface (SPI interface) is one of three major serial communication interfaces of the FPGA. Through the SPI interface, high-speed data communication may be carried out with various peripheral devices. As shown in the above embodiments, if the FPGA is never able to detect high and low pulses with high and low changes, the information will be notified to the microcontroller on the motherboard through the SPI interface. The microcontroller receives the result information and performs determination processing.

In S34, when the microcontroller determines that the operating system of the target storage server fails to start based on the detection result, the microcontroller controls the enable switch on the motherboard of the target storage server to be an off state by sending a non-enable signal, so that the target storage server performs a power-off refresh operation to restart the operating system of the target storage server.

In S35, the timer provided in the target storage server is used to trigger the microcontroller to control the enable switch on the motherboard of the target storage server to switch to the on state by sending an enable signal.

In some embodiments of the present application, when the target storage server fails to start due to hardware damage, the failed device may be replaced. However, the solution may not be applicable when the target storage server fails to start due to firmware bug defects. In fact, the problem of probabilistic failure of the motherboard to start due to firmware bug defects is widely found in server storage products, and the failure is not easy to be reproduced. However, its occurrence is probabilistic, so the replacement solution is not applicable. In this embodiment, in the above steps, the FPGA and the microcontroller cooperate to find that the storage server product fails to start. For startup failures caused by firmware failures, the target storage server may be automatically controlled to restart to overcome the failure.

Specifically, when the microcontroller determines that the operating system of the target storage server fails to start based on the detection result, the microcontroller controls the enable switch on the motherboard of the target storage server to be an off state by sending a non-enable signal, so that the target storage server performs a power-off refresh operation to restart the operating system of the target storage server. That is, after the microcontroller determines that the target storage server fails to start, it controls a general power-on enable switch on the motherboard to turn off. After this process, the operating system will restart due to the power-off refresh operation, which will solve the problem of operating system startup failure to a certain extent.

Furthermore, due to the presence of the timer, the power-on enable switch will be enabled again within a certain period of time, i.e., the timer provided in the target storage server is used to trigger the microcontroller to control the enable switch on the motherland of the target storage server motherboard to switch to the on state by sending the enable signal. During development of a certain storage server product, there was a problem that the operating system could not be started normally. Firmware failures may be avoided to a certain extent by the solution of the embodiment.

It may be seen that, in some embodiments of the present application, the real-time digital signal sent by the operating system of the target storage server is firstly received during the startup of the target storage server; where the real-time digital signal contains a pulse flag bit representing the startup state of the target storage server. Then, the real-time digital signal is detected according to the predetermined detection period to obtain the detection result. When the underlying control chip provided in the target storage server is a FPGA, the FPGA sends the detection result to the microcontroller provided in the target storage server through the serial peripheral interface, so that the microcontroller determines whether the target storage server is started successfully based on the detection result. Based on this, if the microcontroller determines that the operating system of the target storage server fails to start based on the detection result, the microcontroller controls the enable switch on the motherboard of the target storage server to be an off state by sending a non-enable signal, so that the target storage server performs the power-off refresh operation to restart the operating system of the target storage server. In addition, the timer provided in the target storage server is used to trigger the microcontroller to control the enable switch on the motherboard of the target storage server to be the on state by sending the enable signal. In some embodiments of the present application, the problem of startup failure of the target storage server due to firmware failure is solved through the cooperation of FPGA and microcontroller.

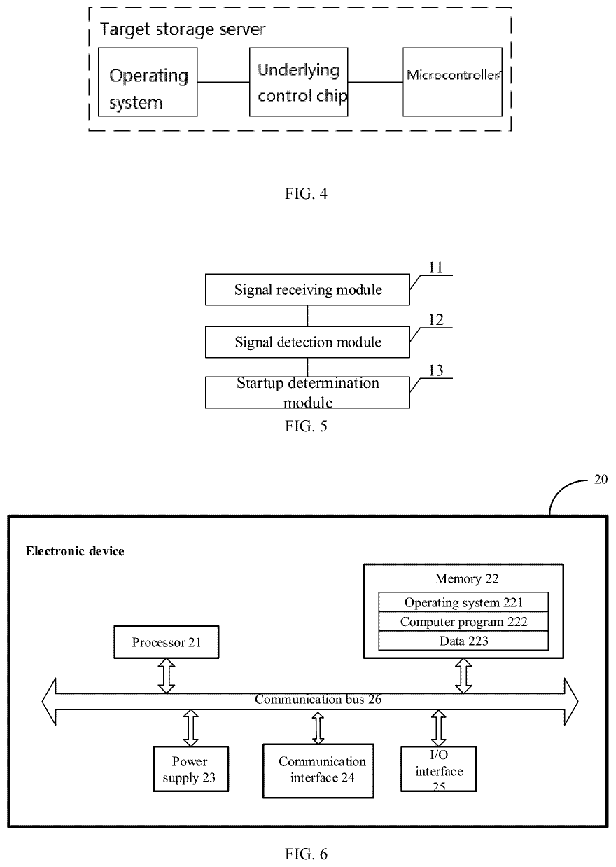

FIG. 4 is a structural diagram of a storage server startup detection system provided in the present application. As shown in FIG. 4, the storage server startup detection system includes an underlying control chip provided in the target storage server, an operating system of the target storage server, and a microcontroller provided in the target storage server.

The underlying control chip provided in the target storage server is configured to receive the real-time digital signal sent by the operating system of the target storage server during startup of the target storage server. The real-time digital signal contains a pulse flag bit representing a startup state of the target storage server.

In some embodiments of the present application. an underlying control chip and a microcontroller are deployed in the target storage server, and the operating system of the target storage server mainly interacts with the underlying control chip for data. The underlying control chip and the microcontroller are original components in the target storage server. In addition to performing their own inherent tasks, they also compatibly perform startup detection tasks for the target storage server.

In some embodiments of the present application. the operating system of the target storage server sends the real-time digital signal to the underlying control chip provided in the target storage server during the startup of the target storage server. The underlying control chip receives the real-time digital signal sent by the operating system of the target storage server. Further, the operating system of the target storage server sends the real-time digital signal to the underlying control chip provided in the target storage server through an input/output interface of a processor provided in the target storage server. The input/output interface is also an I/O interface.

It should be noted that the real-time digital signal contains a pulse flag bit that represents the startup state of the target storage server. In subsequent detection, the underlying control chip mainly detects the pulse flag bit in the real-time digital signal. The pulse flag bit may be a high or low level flag, such as “0” or “1”. The change of the pulse flag bit may be used to reflect whether the target storage server is started successfully and enters the operating system successfully. Therefore, the real-time digital signal is essentially a signal representing that the operating system has been started. The operating system transmits the signal representing that the operating system has been started to the underlying control unit. i.e., the underlying control chip provided in the target storage server, through the I/O interface of the processor CPU.

The underlying control chip provided in the target storage server is also configured to detect the real-time digital signals according to a predetermined detection period, obtain a detection result, and send the detection result to the microcontroller provided in the target storage server.

In some embodiments of the present application, after the underlying control chip receives the real-time digital signal sent by the operating system, the underlying control chip detects the real-time digital signal based on the predetermined detection period, and finally obtains the corresponding detection result. It may be understood that the detection process of the underlying control chip may be considered as passive detection or active detection. The passive detection is due to a fact that the underlying control chip needs to detect the real-time digital signal after receiving it, and the active detection is due to a fact that the underlying control chip actively detects the real-time digital signal after receiving it.

The microcontroller provided in the target storage server is configured to determine whether the target storage server is started successfully based on the detection result.

In some embodiments of the present application, after the underlying control chip detects the real-time digital signal, the detection result is sent to the microcontroller provided in the target storage server, and the microcontroller determines whether the target storage server is started successfully based on the detection result. The microcontroller is located on the motherboard. After receiving the detection result, the microcontroller performs determination processing. It has its own determination logic. By executing the determination logic, it may determine whether the target storage server is started successfully based on the detection result.

As shown in FIG. 5, the present application further discloses a storage server startup detection apparatus applied to the underlying control chip provided in the target storage server, including:

a signal receiving module 11 configured to receive a real-time digital signal sent by an operating system of the target storage server during startup of the target storage server; where the real-time digital signal contains a pulse flag bit representing a startup state of the target storage server;

a signal detection module 12 configured to detect real-time digital signals according to a predetermined detection period to obtain a detection result;

a startup determination module 13 configured to send the detection results to the microcontroller provided in the target storage server, so that the microcontroller determines whether the target storage server is started successfully based on the detection result.

It may be seen that, in some embodiments of the present application, the real-time digital signal sent by the operating system of the target storage server is firstly received during the startup of the target storage server, and the real-time digital signal contains a pulse flag bit representing the startup state of the target storage server. Then, the real-time digital signal is detected based on the predetermined detection period to obtain the detection result. Finally, the detection result is sent to the microcontroller provided in the target storage server, so that the microcontroller may determine whether the target storage server is started successfully based on the detection result. In some embodiments of the present application, the executive object is the underlying control chip. The operating system is configured to send the real-time digital signal to the underlying control chip. After receiving the real-time digital signal, the underlying control chip continuously detects it and sends the detection result to the microcontroller. The microcontroller determines the startup result of the target storage server based on this. The target storage server detects the startup result of the target storage server based on data interaction between the operating system, the underlying control chip and the microcontroller, thereby solving the problem of startup failure of the target storage server.

In some specific embodiments, the storage server startup detection apparatus further includes:

a signal sending module configured for the operating system of the target storage server to send the real-time digital signal to the underlying control chip provided in the target storage server through an input/output interface of a processor provided in the target storage server;

a determination module configured to determine that high and low pulses satisfying the predetermined change condition are not present in the pulse flag bit when the high and low pulses with a predetermined change period are detected to be not present in the pulse flag bit in the real-time digital signal within a predetermined time.

a first control module configured for the microcontroller to control the enable switch on the motherboard of the target storage server to be an off state by sending a non-enable signal when the microcontroller determines that the operating system of the target storage server fails to start based on the detection result;

a restart module configured for the target storage server to perform a power-off refresh operation to restart the operating system of the target storage server;

a second control module configured for a timer provided in the target storage server to trigger the microcontroller to control the enable switch on the motherboard of the target storage server to be an on state by sending an enable signal.

In some specific embodiments, the signal detection module 12 is specifically configured to detect the pulse flag bit in the real-time digital signal according to the predetermined detection period. When high and low pulses satisfying the predetermined change condition are detected to be not present in the pulse flag bit, the first detection result representing that the high and low pulses satisfying the predetermined change condition are not detected is generated.

In some specific embodiments, the signal detection module 12 specifically includes:

a value setting unit configured to set the value of the predetermined detection period to a value not lower than the detection frequency threshold according to the detection requirements; and

a detection unit configured to detect the real-time digital signal in real time based on the set value of the predetermined detection period, so to obtain a detection result.

In some specific embodiments, the value setting unit is specifically configured to set the value of the predetermined detection period to 50 Mhz according to a high-frequency detection requirement, so that the underlying control chip detects the real-time digital signal in real time at a rate of 50 Mhz.

In some specific embodiments, the startup determination module 13 is specifically configured to send the first detection result to the microcontroller provided in the target storage server, so that the microcontroller determines that the target storage server fails to start based on the first detection result.

In some specific embodiments, the startup determination module 13 is specifically configured for a FPGA to send the first detection result to the microcontroller provided in the target storage server through the serial peripheral interface when the underlying control chip provided in the target storage server is a FPGA.

Furthermore, the present application further provides an electronic device. FIG. 6 is a structural diagram of an electronic device 20 according to an exemplary embodiment. The content in the figure cannot be considered as any limitation on the scope of the present application.

FIG. 6 is a schematic structural diagram of an electronic device 20 provided in the present application. The electronic device 20 may specifically include: at least one processor 21, at least one memory 22, a power supply 23, a communication interface 24, an input/output interface 25 and a communication bus 26. The memory 22 is configured to store a computer program. The computer program is loaded and executed by the processor 21 to implement relevant steps in the storage server startup detection method disclosed in any of the foregoing embodiments.

In some embodiments of the present application. the power supply 23 is configured to provide operating voltage for each hardware device on the electronic device 20. The communication interface 24 may create a data transmission channel between the electronic device 20 and external devices, and the communication protocol it follows is any communication protocol that can be applied to the technical solution of the present application, which is not specifically limited herein. The input/output interface 25 is configured to obtain input data from the outside world or output data to the external world, and its specific interface type may be selected according to specific application needs, which is not specifically limited herein.

In addition, the memory 22 serves as a carrier for resource storage, which may be a read-only memory, a random access memory, a magnetic disk or an optical disk, etc. The resources stored thereon may include an operating system 221, a computer program 222 and data 223, etc., and the storage method may be transitory storage or permanent storage.

The operating system 221 is configured to manage and control each hardware device on the electronic device 20 and the computer program 222 to realize computation and processing of the massive data 223 in the memory 22 by the processor 21, which may be Windows Server, Netware, Unix, Linux, etc. In addition to computer programs that may be used to perform the storage server startup detection method performed by the electronic device 20 disclosed in any of the above embodiments, the computer program 222 may further include computer programs that may be used to complete other specific tasks. Data 223 may include real-time digital signals collected by electronic device 20.

Further, the present application further discloses a non-transitory readable storage medium. A computer program is stored in the non-transitory readable storage medium. The computer program, when loaded and executed by the processor, implements steps of the storage server startup detection method disclosed in any of the above embodiments.

Various embodiments in this specification are described in a progressive manner, and each embodiment focuses on the differences with other embodiments. The same or similar parts of various embodiments can be referred to each other. As for the apparatus disclosed in the embodiment, since it corresponds to the method disclosed in the embodiment, the description is relatively simple. For relevant details, please refer to the description in the method section.

Finally, it should also be noted that in this specification, relational terms such as first and second are used only to distinguish one entity or operation from another entity or operation without necessarily requiring or implying any such actual relationship or order between these entities or operations. Moreover, the term “including”, “containing” or any other variant is intended to cover non-exclusive inclusion, so that a process, a method, an articles, or a device that includes a series of elements includes not only those elements, but also other elements that are not clearly listed, or also includes the inherent elements of the process, method, articles or device. Without more restrictions, the limited elements by the sentence “includes a . . . ” do not exclude that there are other same elements in the process, method, article, or device that include the elements.

The storage server startup detection method, apparatus, device and storage medium provided in the present application have been introduced in detail above. In the specification, specific examples are used to illustrate the principles and implementation methods of the application. The description of the above embodiments is only used to help understand the methods and core ideas of the present application. For those of ordinary skill in the art, there will be changes in the specific implementation methods and application scope based on the ideas of the present application. In summary, the content of the specification should not should be understood as a limitation on the present application.

1. A storage server startup detection method applied to an underlying control chip provided in a target storage server, comprising:
receiving a real-time digital signal sent by an operating system of the target storage server during startup of the target storage server, wherein the real-time digital signal comprises a pulse flag bit representing a startup state of the target storage server;
detecting the real-time digital signal based on a predetermined detection period to obtain a detection result; and
sending the detection result to a microcontroller provided in the target storage server, so that the microcontroller determines whether the target storage server is started successfully based on the detection result.

2. The storage server startup detection method according to claim 1, wherein before the receiving the real-time digital signal sent by the operating system of the target storage server, the method further comprises:
sending, by the operating system of the target storage server, the real-time digital signal to the underlying control chip provided in the target storage server through an input/output interface of a processor provided in the target storage server.

3. The storage server startup detection method according to claim 2, wherein the sending, by the operating system of the target storage server, the real-time digital signal to the underlying control chip provided in the target storage server through the input/output interface of the processor provided in the target storage server comprises:
transmitting, by the operating system of the target storage server, a signal indicating that the operating system has been started to the underlying control chip provided in the target storage server through the input/output interface of the processor provided in the target storage server.

4. The storage server startup detection method according to claim 1, wherein the sending the detection result to the microcontroller provided in the target storage server, so that the microcontroller determines whether the target storage server is started successfully based on the detection result, comprises:
sending the detection result to the microcontroller provided in the target storage server, so that the microcontroller performs a determination logic to determine whether the target storage server is started successfully based on the detection result.

5. The storage server startup detection method according to claim 1, wherein the detecting the real-time digital signal based on the predetermined detection period to obtain the detection result comprises:
detecting the pulse flag bit in the real-time digital signal based on the predetermined detection period, and generating a first detection result representing that high and low pulses satisfying a predetermined change condition are not detected in the pulse flag bit when the high and low pulses satisfying the predetermined change condition are detected to be not present in the pulse flag bit.

6. The storage server startup detection method according to claim 5, further comprising:
determining that the high and low pulses satisfying the predetermined change condition are not present in the pulse flag bit when the high and low pulses with the predetermined change period are detected to be not present in the pulse flag bit in the real-time digital signal within a predetermined time.

7. The storage server startup detection method according to claim 5, wherein the sending the detection result to the microcontroller provided in the target storage server, so that the microcontroller determines whether the target storage server is started successfully based on the detection result, comprises:
sending the first detection result to the microcontroller provided in the target storage server, so that the microcontroller determines that the target storage server fails to start based on the first detection result.

8. The storage server startup detection method according to claim 7, wherein the sending the first detection result to the microcontroller provided in the target storage server comprises:
sending, by a field programmable gate array, the first detection result to the microcontroller provided in the target storage server through a serial peripheral interface when the underlying control chip provided in the target storage server is the field programmable gate array.

9. The storage server startup detection method according to claim 1, wherein the detecting the real-time digital signal based on the predetermined detection period to obtain the detection result, comprises:
setting a value of the predetermined detection period to be not lower than a detection frequency threshold according to a detection requirement; and
detecting the real-time digital signal in real time based on the set value of the predetermined detection period to obtain the detection result.

10. The storage server startup detection method according to claim 9, wherein the detection requirement comprises detection accuracy, and setting the value of the predetermined detection period to be not lower than the detection frequency threshold based on the detection requirement comprises:
setting a detection period based on the detection accuracy.

11. The storage server startup detection method according to claim 9, wherein the setting the value of the predetermined detection period to be not lower than the detection frequency threshold based on the detection requirement comprises:
setting the value of the predetermined detection period to 50 Mhz according to a high-frequency detection requirement, so that the underlying control chip detects the real-time digital signal in real time at a rate of 50 Mhz.

12. The storage server startup detection method according to claim 1, wherein after the sending the detection result to the microcontroller provided in the target storage server, so that the microcontroller determines whether the target storage server is started successfully, the method further comprises:
controlling the target storage server to restart when the microcontroller determines that the target storage server fails to start based on the detection result.

13. The storage server startup detection method according to claim 12, wherein the controlling the target storage server to restart when the microcontroller determines that the target storage server fails to start based on the detection result, comprises:
controlling the target storage server to restart when the microcontroller determines that the target storage server fails to start due to firmware failure based on the detection result.

14. The storage server startup detection method according to claim 1, wherein after the sending the detection result to the microcontroller provided in the target storage server, so that the microcontroller determines whether the target storage server is started successfully, the method further comprises:
controlling, by the microcontroller, an enable switch on a motherboard of the target storage server to be an off state by sending a non-enable signal when the microcontroller determines that the operating system of the target storage server fails to start based on the detection result.

15. The storage server startup detection method according to claim 14, wherein after the controlling, by the microcontroller, the enable switch on the motherboard of the target storage server to be the off state by sending the non-enable signal, the method further comprises:
performing, by the target storage server, a power-off refresh operation to restart the operating system of the target storage server.

16. The storage server startup detection method according to claim 14, wherein after the controlling, by the microcontroller, the enable switch on the motherboard of the target storage server to be the off state by sending the non-enable signal, the method further comprises:
triggering, by a timer provided in the target storage server, the microcontroller to control the enable switch on the motherboard of the target storage server to be an on state by sending an enable signal.

17. A server startup detection system, comprising an underlying control chip provided in a target storage server, an operating system of the target storage server and a microcontroller provided in the target storage server, wherein:
the underlying control chip provided in the target storage server is configured for receiving a real-time digital signal sent by the operating system of the target storage server during startup of the target storage server, detecting the real-time digital signal based on a predetermined detection period to obtain a detection result, and sending the detection result to the microcontroller provided in the target storage server, wherein the real-time digital signal comprises a pulse flag bit representing a startup state of the target storage server; and
the microcontroller provided in the target storage server is configured for determining whether the target storage server is started successfully based on the detection result.

18. (canceled)

19. An electronic device, wherein the electronic device comprises a processor and a memory for storing a computer program, and the computer program is loaded and executed by the processor to implement the server startup detection method according to claim 1.

20. A non-transitory computer-readable storage medium, wherein the non-transitory computer-readable storage medium stores a computer-executable instruction which, when loaded and executed by a processor, implements the server startup detection method according to claim 1.

21. The storage server startup detection method according to claim 1, wherein the pulse flag bit is a high level flag or a low level flag.
